(19) United States
(12) Patent Application Publication
(10) Pub. No.: US 2013/0016212 A1
(43) Pub. Date: Jan. 17, 2013

(54) System and Method for Using Capacitors in Security Devices

(71) Applicants: William P. Laceky, Georgetown, TX (US); Marty Akins, Austin, TX (US); William Bryant, Austin, TX (US); Bryan Lee, Austin, TX (US)

(72) Inventors: William P. Laceky, Georgetown, TX (US); Marty Akins, Austin, TX (US); William Bryant, Austin, TX (US); Bryan Lee, Austin, TX (US)

(73) Assignee: BATTERY-FREE OUTDOORS, LLC, Austin, TX (US)

(21) Appl. No.: 13/352,800

(22) Filed: Jan. 18, 2012

Related U.S. Application Data
(60) Provisional application No. 61/433,833, filed on Jan. 18, 2011.

(51) Int. Cl. H04N 7/18

(52) U.S. Cl. 348/143; 348/E07.085

(57) ABSTRACT

A battery-free security system is provided with one or more series or parallel capacitive networks. One or more solar panels are used to charge the capacitive networks and one or more charging circuits are used to control the charging of the capacitive networks. One or more DC-DC converters may be used to provide a voltage to a load, the timer/clock circuitry, and a user interface. In those instances when it is desired that the timer/clock circuitry remain powered at all times, the timer/clock circuitry is preferentially preserved at the expense of the load such that if, for any reason, the capacitive network is drained after running the load, there will still be sufficient power stored in the capacitive network to maintain the timer/clock circuitry.

### PRIORITY STATEMENT UNDER 35 U.S.C. §119 & 37 C.F.R. §1.78

This non-provisional application claims priority based upon prior U.S. Provisional Patent Application Ser. No. 61/433,833 filed Jan. 18, 2011 in the name of William P. Laceky, Marty Akins, William Bryant and Bryan Lee entitled “Battery-Free Methods and Systems,” the disclosure of which is incorporated herein in its entirety by reference as if fully set forth herein.

### BACKGROUND OF THE INVENTION

There are an extremely wide variety of products suitable for use in the security industry that utilize batteries or solar cells/solar panels or a combination of both batteries and solar panels to power the products. However, in many cases, the batteries are a major cause of failure and maintenance. A product that uses only batteries without a solar charging device will require the end user to periodically charge or change the battery. Even batteries charged by solar cells or solar panels will require user maintenance due to the inherent limitations of batteries that cause the battery to degrade and fail over time, in addition to the influence of many other factors such as temperature, charge rate, depth of discharge, vibration, etc. Depending on the duty of the product, the user may have to recharge the battery anywhere from daily to yearly. A device that uses solar cells/solar panels along with batteries typically requires less maintenance since the solar energy is used to charge the batteries during the day and the batteries power the electrical circuit at night. This cycle helps keep the battery from completely discharging, reducing user charging or changing maintenance. However, the physical properties of batteries are such that the battery is typically limited to several hundred recharging cycles. Moreover, the number of recharging cycles is negatively affected by variations of the ambient temperature surrounding the batteries. Since these products are designed for use in an outdoor environment where the batteries are exposed to extreme cold and hot conditions, the batteries typically reach an early end of life ranging from days to several years depending on their usage and environmental surroundings.

The present invention provides several advantages over the prior art including: a longer life compared to systems that rely on rechargeable batteries; the reduction or elimination of battery maintenance; a lighter weight system; superior temperature tolerance; almost unlimited use (charging and discharging); and a system that is more environmentally friendly than battery-based systems.

Those skilled in the art can readily determine the voltage at given points in time during the discharging or charging of the capacitors. The capacitors would be discharging due to the load presented by the products function being powered by the capacitors. The capacitors can be charging under various conditions and circumstances depending on the product's intended function, design, type of charging power source, and how much charging energy is available from the source at any given time. (an example of capacitor discharging would be power required from the capacitor(s) to power the control circuitry of the device). To maximize the energy stored in these capacitors, a DC to DC converter can be used to step the capacitor voltage up or down to obtain a steady power supply for the device as the capacitor voltages drop. For example, a DC to DC charge-pump or switch-mode circuit could be used to convert the 6V capacitor voltage to 6V DC even as the capacitor voltage falls below 6 volts. This provides the maximum amount of energy from the capacitors to be used for powering the device circuits, allowing the designer to minimize the number of capacitors used in the design while maintaining the appropriate duration of available power between re-charges from the solar panel.

### SUMMARY OF THE INVENTION

According to one aspect of the invention, a battery-free security system is adapted with one or more series or parallel capacitive networks. One or more solar panels are used to charge the capacitive networks and one or more charging circuits are used to control the charging of the capacitive networks. One or more DC-DC converters may be used to provide a voltage to a load, the timer/clock circuitry and a user interface. In those instances when it is desired that the timer remain powered at all times, the control circuitry is preferentially preserved at the expense of load such that if, for any reason, the capacitive network is drained after running the load, there will still be sufficient power stored in capacitive network to maintain the control circuitry needed to maintain the desired operation of the system.

The foregoing has outlined rather broadly certain aspects of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present invention is illustrated by way of example and not limitation in the figures of the accompanying drawings, in which like references indicate similar elements and in which:

FIG. 1 is a block diagram showing a basic depiction of a system using capacitive energy storage in place of battery energy storage;

FIG. 2 is a block diagram of an system used to power a load of the present invention;

FIG. 3 is a block diagram of an example of a camera system or other load using capacitive energy storage;

FIG. 4 is a block diagram showing another embodiment of a system for powering a load of the present invention;

FIG. 5 is a block diagram illustrating circuitry for powering a load and for powering other circuitry using energy stored in capacitive networks;

FIGS. 6 and 7 are block diagrams illustrating other embodiments of the present invention;

FIG. 8 is a block diagram of another example of a system for powering a camera or other load using capacitive energy storage; and

FIG. 9 is a block diagram of another example of a system for powering a camera or other load using capacitive energy storage.

### DETAILED DESCRIPTION OF THE INVENTION

The present invention contemplates systems powered by energy stored in capacitors. For example, a system may include an security camera or a security sensor (or some other device) that draws power from one or more capacitors. In this example, energy stored in the capacitors comes from one or more power supplies. If desired, the system can be operated without batteries, which may increase the reliability and life span of the system. The present invention may be used with any desired security device that requires a power source for providing power to a motor, and/or any other power dissipating devices. The invention may be used for applications beyond those set forth in this application, as persons of ordinary skill in the art who have the benefit of the description of the invention will understand.

The present invention includes a power storage module using one or more capacitors to store energy. As discussed above, one of the problems with prior art systems is that batteries fail in a relatively short amount of time and require more difficult recharging efforts. The power storage module of the present invention solves this problem with the introduction of capacitive storage. The capacitors used in this invention have a much longer life expectancy than batteries and are much easier to charge. Thus, this invention requires a smaller and less expensive solar panel than other comparable battery operated and solar charged devices. Also, the capacitors can be discharged completely without any negative effect, whereas batteries typically cannot be discharged below 80% of their capacity without damage.

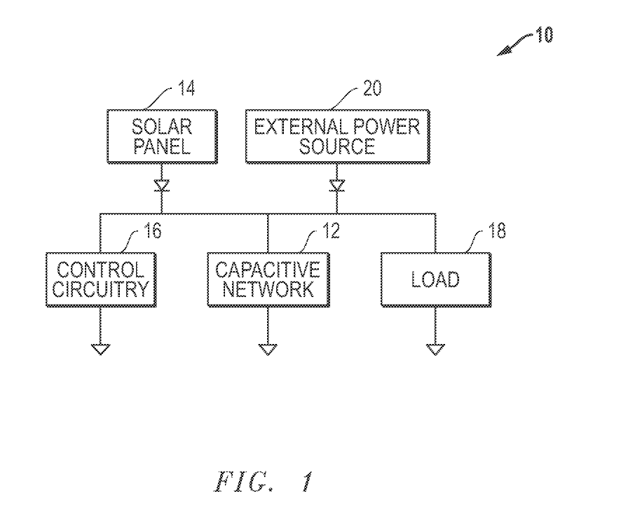

FIG. 1 is a basic depiction of a system 10 using capacitive energy storage in place of battery energy storage. FIG. 1 shows a capacitive network 12, which is coupled to solar panel 14. The capacitive network may be comprised of a single capacitor or multiple capacitors. Multiple capacitors could be placed in series, parallel, or in a series-parallel configuration. These configurations could exist as a single configuration or as multiple configurations depending on the voltage and current requirements of the operating circuit. FIG. 1 also shows control circuitry 16 and a load 18 coupled to the capacitive network 12 and solar panel 14. The control circuitry 16 may include circuitry to control the operation of the load, as well as circuitry to control the charging and discharging of the capacitive network 12.

Capacitor technology using high dielectric films such as, but not limited to “Aerogel” allow large amounts of energy storage to exist in relatively small packages. Capacitors have a much greater (almost infinite) number of charge and discharge cycles compared to batteries. Capacitors are also far less affected by temperature. Using the concepts taught by the present invention, the density of the energy storage of capacitors allows adequate energy storage in capacitor form to replace batteries in many devices. Given the longer life properties of capacitors, devices using capacitors instead of batteries dramatically reduce required user maintenance. The security systems and products contemplated herein use capacitors in place of batteries along with an adequate power supply, such as solar cells/solar panels, to repeatedly charge the capacitors during the day so they can be left unattended for years without maintenance.

While a person skilled in the art could utilize numerous storage modules using capacitors, following are some general guidelines for using capacitors in the products contemplated herein. Typically, capacitors have a working voltage that should not be exceeded. Capacitors also have an internal series resistance that may be taken into account along with the current demand that will be put on them. Capacitors can be connected in series to increase the stored voltage capability of the network. A series connection comes at the expense of decreasing the capacitance (Farads) of the network. Capacitors, or series strings of capacitors, can be connected in parallel to increase the capacitance value of the overall network. It may be necessary to balance the capacitors in series or in a series/parallel combination to, among other things, counteract the effects of variance in capacitance and leakage current and protect the capacitors from overvoltage. Balancing capacitors in series can be done in several ways, for instance, passively or actively. Passively, requires an appropriate sized load be placed permanently in parallel with each capacitor to be balanced. Placing a resistor across each capacitor would be a passive way to keep the voltages balanced reasonably equally from one capacitor to another. However, this method does not protect well against overvoltage of the capacitors. This method also presents a load to the circuit which continuously drains the capacitors. In most cases this is undesirable. In some applications, it may be desirable or imperative to provide balancing and overvoltage protection that is much faster and more accurate than passive methods. In this case active control is necessary. This can be done in several ways. One method but certainly not the only method would be to sense the voltage across each capacitor individually, then making a logical decision as to whether the voltage is too high or too low or in an acceptable range. In this example, a load can be turned ON or OFF in parallel with the capacitor of interest. Turning ON a parallel load allows energy to be drained out of the capacitor. Turning OFF the load allows the capacitor to continue to build charge. The parallel load can be adjusted by design to create an appropriately sized load to achieve the balance required within a specific amount of time. The ability to turn this load ON/OFF conserves energy until excess energy is present, making it a very efficient method to balance and maintain voltage levels across individual capacitors in a series or series/parallel string.

It is important to note that one cannot simply replace a battery with a capacitor and be able to effectively operate most battery operated products. Capacitors have many differences that require technology advances and significant engineering skills and design work to effectively use them in place of batteries.

One significant difference between batteries and capacitors is their energy densities and discharge characteristics. Batteries typically have a flat voltage level as they discharge to the end of their capacity. Capacitors have a different discharge profile, where the voltage falls quickly at first then slowing as it is discharged to the end of its capacity. So, for example, a 6V battery used to run a 6V motor in a device will provide a good steady 6V to the device through most of its charge without any additional help. On the other hand, a capacitor or combination of capacitors charged to 6V running the same device will quickly fall to 4V, then 2V, then 1V, etc., as it reaches the end of its charge. A 6V motor, for example, will not run very well, if at all, with these low voltages. The circuitry of the present invention overcomes these problems, allowing the device to run on capacitors.

Energy density also presents a major challenge when trying to replace batteries with capacitors. Batteries may have much more stored energy than capacitors. For example, a lead acid battery might run a 6V, 3 A device for a couple of hours. A capacitor of similar cost to the battery might only be able to run that device for a few seconds before running out of energy. The capacitor alone would not be able to even do this without specially designed conversion circuitry that efficiently takes most of the usable energy in the capacitor and converts it into usable energy for the device.

In many cases, one power consuming device attached to the capacitors, such as a clock or control circuitry, preferably should be able to run indefinitely (without power interruption) for years without intervention or help from anyone. It must be able to do this with the only energy source to charge it, such as solar energy through a solar panel (photovoltaic). The product should achieve this through periods of darkness (due to nighttime and days of heavy cloud cover, rain, and snow). Likewise, another power consuming device attached to the capacitors should preferably be able to run at a constant energy draw for a finite amount of time each day in these same conditions. Consequently, there are significant design challenges in order to achieve this performance.

Returning now to FIG. 1, which also shows the connection of an external power source 20, which may be used in addition to the solar panel, or as an alternative method, for charging the capacitive network 12. The external power source 20 may include an external charger, batteries, solar panels, solar collectors, wind generators, wave action generators, electrolyzers, fuel cells, piezo electric films or elements or generators, AC/DC motors and generators and other power generation or storage devices.

Alternatively, a manual power source could be included such as, for example, oscillating a magnet through a coil of wire by shaking to generate electricity for charging the capacitor. More specifically, a hollow elongated barrel may be disposed within a housing, a wire coil wrapped around the barrel and disposed between the barrel and the housing, a magnet may be disposed within the barrel and sized to freely oscillate within the barrel when the barrel is shaken. In one embodiment, two springs are attached within the barrel and at either end of the barrel to cause the magnet to recoil when the magnet strikes the springs. The magnet oscillates within the barrel when the barrel is shaken, causing the magnet to pass back and forth through the wire coil, thereby causing current to flow within the coil and providing power to the capacitors.

Also, it is important to note that in many of the examples shown below, a DC-DC converter is included between the capacitors and the load. Those skilled in the art will realize that it will not always be necessary to include a DC-DC converter and in other cases other convertors or devices to accommodate the specific capacitor configuration and load requirements.

As can be appreciated by those skilled in the art, the present invention is capable of use in connection with a wide variety of loads. For example, the power system of the present invention can be used to power security lights, security cameras, security sensors, and similar devices. Such devices may be operated under constant/regulated voltage and current requirements or non-constant or unregulated voltages and/or currents for defined periods of time. In addition, in certain embodiments, the invention provides a system that runs electronic circuitry such as digital clock circuitry, motor control circuitry, and data storage circuitry, indefinitely without power interruption using, for example, a combination of stored solar energy and direct solar energy.

By way of example, safety lights are often located in areas without power such as, in road signage where there are times when it is necessary to alert vehicular traffic to potential obstructions when it is dark or visibility is limited. Traditionally red or yellow warning lights are spaced at intervals around an obstruction to designate a hazardous area. In many cases, individual battery operated lights placed along the tops of barriers, fencing and the like. These lights have had to be secured against theft, as well as checked regularly for proper operation. Even though electric eye switches are used to turn them on and off, batteries must be frequently replaced and maintenance of these lights has become an increasingly expensive and burdensome requirement for those using the lights.

In many cases, it may be desirable to provide control circuitry in connection with safety lighting. Such control circuitry may be used to control the times at which the lights are cycled on and off, or may be used to communicate with a central stations so that, for example, the lights can all be controlled through a central circuit. In such case, a first DC-DC converter provides a voltage to the timer/clock circuitry and a second DC-DC converter provides a voltage to the light. In this system, it is desired that the timer remain powered at all times. If, for some reason, the capacitive network is completely drained after running the light, there will still be sufficient power stored in the capacitive network to power the timers and clocks needed to maintain the desired operation of the system. Without this separation, the light could rob the timer of needed energy. Separate solar panels may be used to help ensure that there is plenty of energy available from sunlight during cloudy days to fully charge both capacitor banks. If desired, a battery could be used as a backup power source in the event that energy stored in the capacitors is depleted. A single solar panel and single capacitor bank could also be used to power both the light and the timer, provided capacitor bank sizing and cutoff circuitry ensures sufficient energy was retained for the timer. Various other methods of configuring such lights with a power source, capacitors and control circuitry are described below and referenced in the Figures.

In another example, security systems are often placed in locations without readily available power, such as cabins, barns, or other remote locations. These security systems are typically equipped with appropriate sensors and detectors, such as smoke detectors, motion detectors, switch sensors, perimeter sensors, and water sensors, to provide protection for real property and tangible assets. Conventional security systems provide protection by activating an alarm when a detector detects an occurrence, such as when a smoke detector detects smoke. The alarm, typically audible or visual, is designed to notify those in the proximate vicinity of an occurrence and to frighten away a potential thief or vandal. However, when a security system of this type is employed in a remote area, the audible and visual alarms are not effective because no one is in the proximate vicinity to respond to the alarm. More specifically, those employing a security system desire a feature that permits the user to monitor the protected asset and the status of the security system from a remote location. For example, when the smoke detector detects smoke, the remote monitoring feature notifies a designated entity at a remote monitoring site, such as police stations, fire stations, the headquarters of a private security service provider, the security system user's home, or even a portable device in communication with the security system. However, when a smoke detector is powered by a battery, loss of power in the battery also causes the power to be lost to the remote monitoring feature.

It would be advantageous, therefore, to have a security system capable of operation in a remote location which preserves power to the device for remote communication (e.g. to transmit the status of the device) even when other functionality, such as all or a portion of the sensors and detectors lose power.

In one embodiment, a power source, such as a solar panel, may be connected to one or more capacitors which provide power to a smoke detector. The device may contain a timer or clock circuitry to, for example, control the periods during which the security camera is active or to communicate with a remote monitoring station. In one embodiment, a first DC-DC converter provides a voltage to the timer/clock circuitry and a second DC-DC converter provides a voltage to the security camera. In this system, it is desired that the timer remain powered at all times. If, for some reason, the capacitive network is completely drained after running the security camera, there will still be sufficient power stored in the capacitive network to maintain the control circuitry (including the remote monitoring portion) needed to maintain the desired operation of the system. Separate solar panels may be used to help ensure that there is plenty of energy available from sunlight during cloudy days to fully charge both capacitor banks. If desired, a battery could be used as a backup power source in the event that energy stored in the capacitors is depleted. A single solar panel and single capacitor bank could also be used to power both the security camera and the timer, provided capacitor bank sizing and cutoff circuitry ensures sufficient energy was retained for the timer. Various other methods of configuring such lights with a power source, capacitors and control circuitry are described below and referenced in the Figures.

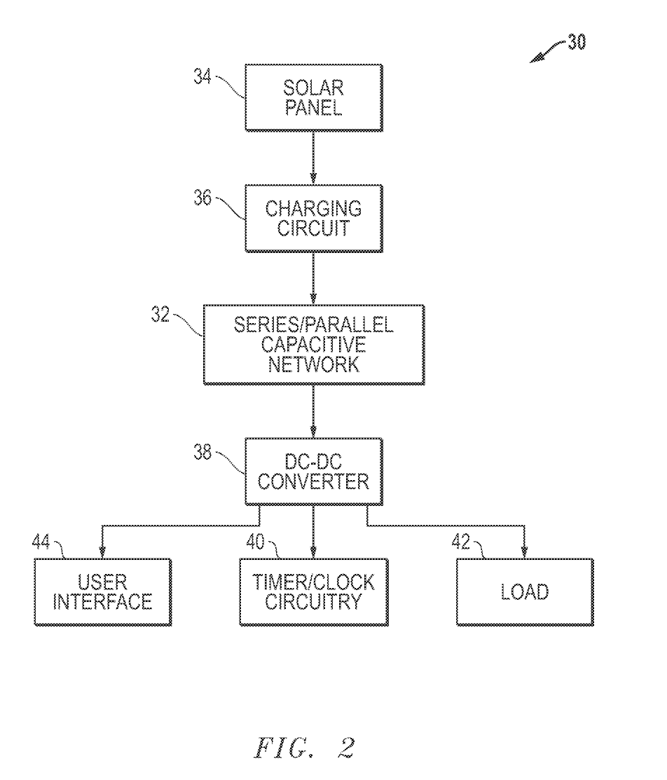

The power that is stored capacitively and provided to one or more loads in each of the foregoing devices and systems may be provided in a variety of ways. For example, FIG. 2 is a block diagram of one embodiment of system of the present invention. The system 30 includes a series/parallel capacitive network 32, such as the network described above. A solar panel 34 is used to charge the capacitive network 32, although any power source previously described could be used. A charging circuit 36 (described in detail below) is used to control the charging of the capacitive network 32. A DC-DC converter 38 is used to step the capacitor voltage up or down to obtain a steady power supply for the device as the capacitor voltages drop. The DC-DC converter provides a voltage to both the timer/clock circuitry 40 and the load 42. FIG. 2 also shows a user interface block 44, which may include a display, lights, switches, keypad, etc., for use by a user to control the operation of the system 30.

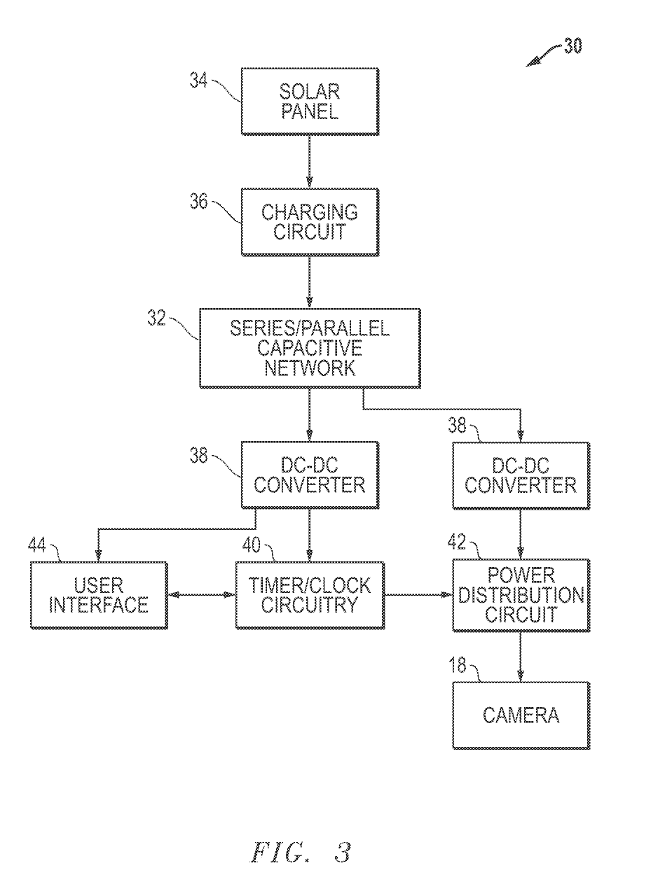

FIG. 3 is similar to the example shown in FIG. 2, except that a separate DC-DC converter is used by the load 42, which is a power distribution circuit. In this embodiment, the power distribution circuit provides power to a security camera 18. FIG. 3 also shows a user interface block 44, which may include a display, lights, switches, keypad, etc., for use by a user to control the operation of the system 30.

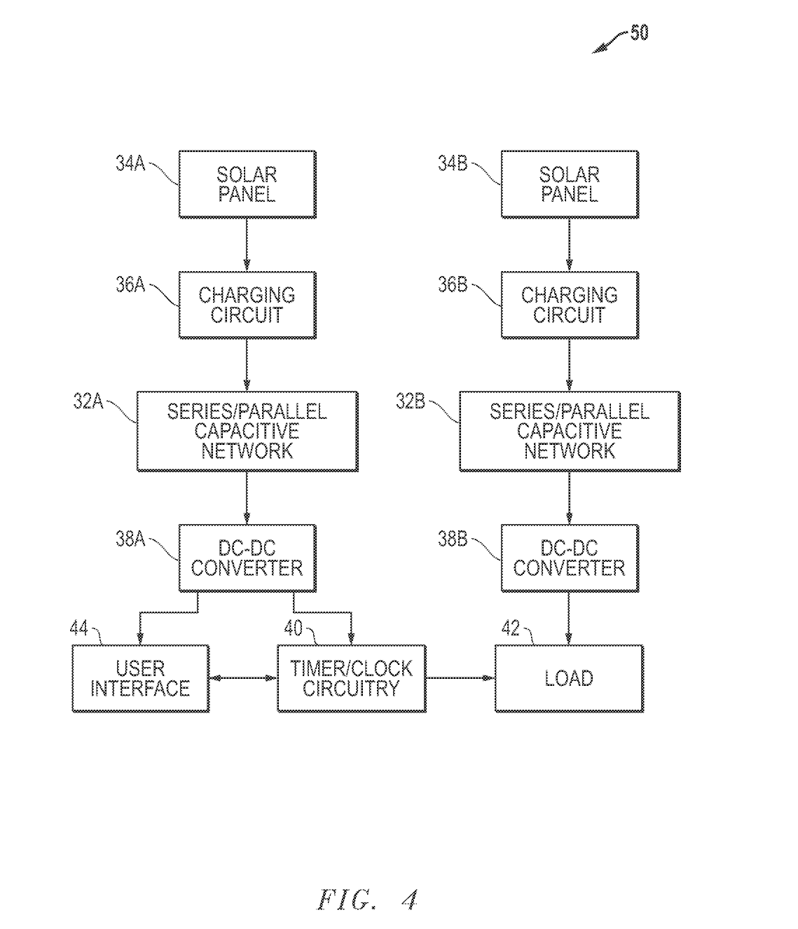

FIG. 4 is a block diagram showing another embodiment of the system. FIG. 4 shows a block diagram of a system 50 that is similar to the system shown in FIG. 2, with separate capacitive networks and solar panels for the load and control circuitry. The system 50 includes first and second series/parallel capacitive networks 32A and 32B. First and second solar panels 34A and 34B are used to charge the capacitive networks 32A and 32B, respectively. Charging circuits 36A and 36B are used to control the charging of the capacitive networks 32A and 32B, respectively. A first DC-DC converter 38A provides a voltage to the timer/clock circuitry 40 and user interface 44. A second DC-DC converter 38B provides a voltage to the load. By separating the source of power to load and the control circuitry, the reliability of the system is increased. In many systems, it is desired that the timer remain powered at all times. If, for some reason, the capacitive network 32B is completely drained after running the load 42, there will still be sufficient power stored in capacitive network 32A to maintain the timers and clocks needed to maintain the desired operation of the system. Without this separation, the load 42 could rob the timer of needed energy. Separate solar panels help ensure that there is plenty of energy available from sunlight during cloudy days to fully charge both capacitor banks. If desired, with either embodiment, a battery could be used as a backup power source in the event that energy stored in the capacitors is depleted.

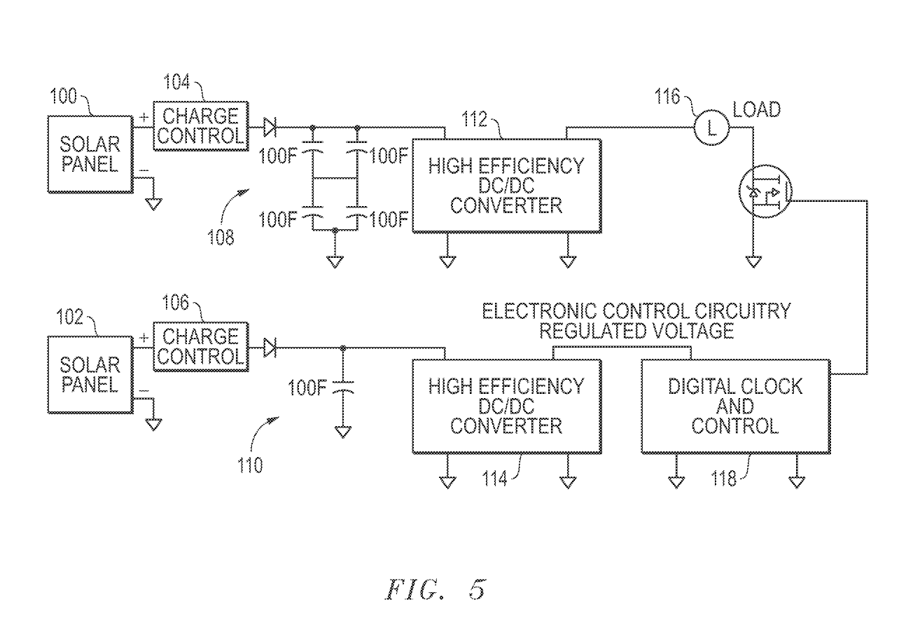

FIG. 5 is a block diagram illustrating circuitry for powering a load and for powering other circuitry using energy stored in capacitive networks. Like in FIG. 4, in the example shown in FIG. 5, separate solar panels and capacitive networks are used to power the load and other circuitry. FIG. 5 shows first and second solar panels 100 and 102 that provide power to charge control circuits 104 and 106, respectively. The solar panels 100 and 102 are ideally sized to provide enough charge (under low light) to run the motor or control circuitry for a desired time between charging periods. The charge control circuits 104 and 106 measures the capacitor charge voltage and protects the capacitors from charging to damaging voltage levels. The charge control circuits do this by shunting the solar panels output away from the capacitor(s) when the voltage reaches an ideal voltage (described in more detail below). The charge control circuits re-connect the solar panels when the capacitor voltage falls below the ideal voltage. In FIG. 5, the capacitive networks 108 and 110 are used to store solar energy collected during the daylight. At night or during low light level conditions, the capacitor networks provide enough energy to keep the clock and control circuitry powered (without interruption) until the solar panel can provide a recharge. As a result, the capacitor networks must be sized accordingly.

The DC-DC converter 112 converts the capacitor voltages to a usable voltage for the load 116. Similarly, DC-DC converter 114 converts the capacitor voltages to a usable voltage for the timer and control circuitry 118. The DC-DC converters 112 and 114 receive energy from both the solar panels 100 and 102 and capacitive networks 108 and 110 during daylight and from only the capacitive networks 108 and 110 during nighttime. The energy stored in the capacitive network 106 keeps the control circuitry powered indefinitely by using most of the available energy in the capacitors (even down to low voltages). The DC-DC converter 112 also provides a regulated voltage output at the appropriate level for a given load. The timer and control circuitry 118 may include an LCD display for showing the time of day and the programming of times at which power is provided to the load. The timer and control circuitry 118 also may include a user interface for the user to customize the operation of the system.

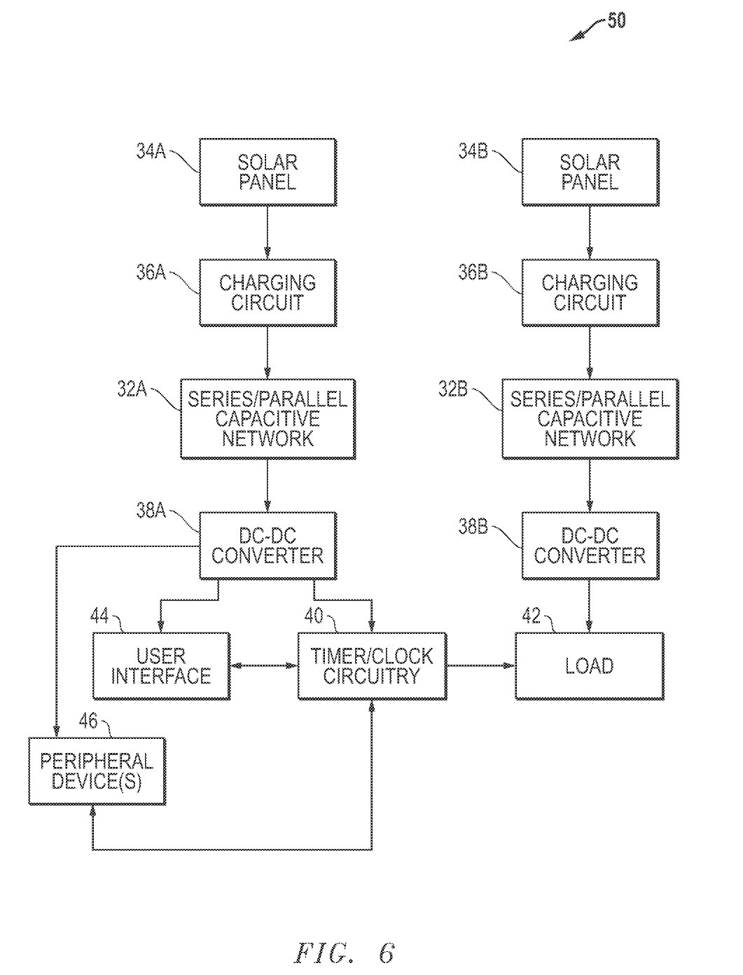

FIG. 6 is a block diagram illustrating another embodiment of the present invention. FIG. 6 is similar to FIG. 4, with the addition of a peripheral device(s) 46. A peripheral device 46 can be powered in the same manner as the circuitry 40. A peripheral device can be controlled by the circuitry 40, or by any other desired manner. The peripheral device(s) 46 may be comprised of any desired device that can work with a capacitively powered system. In one example, the load may be a security camera and the peripheral device may be a wireless communication apparatus, such as a cellular telephone apparatus. In this example, the wireless communication apparatus allows a user to remotely program or control the system. In addition, the wireless communication apparatus can be used to provide system status to a remote user. For example, if used in conjunction with a security camera, the wireless communication apparatus can notify a user when the system requires attention. The wireless communication apparatus can also provide alarms to notify a user of detected faults or other conditions. In another example, a peripheral device is an optical sensor. An optical sensor can be used to allow a user to manually operate the system from a distance.

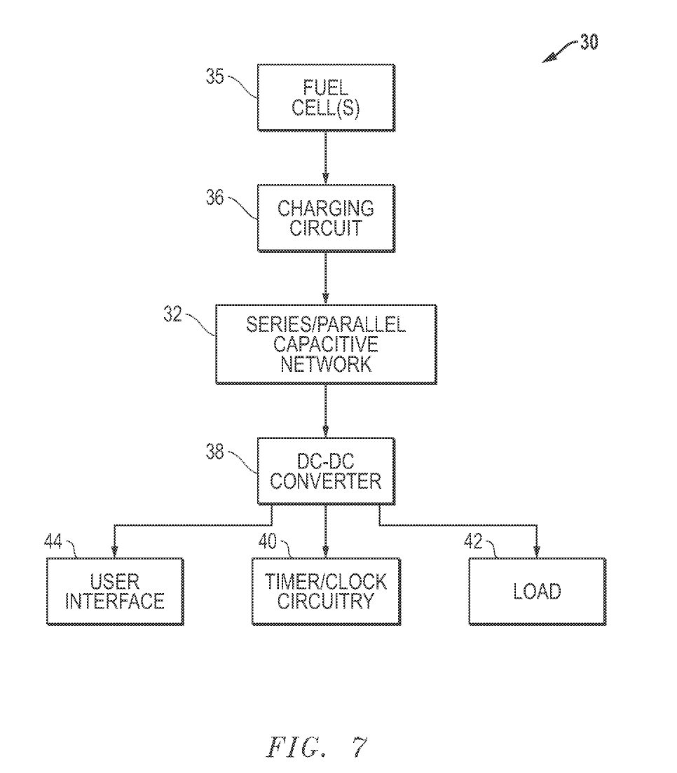

FIG. 7 is a block diagram illustrating another embodiment of the present invention. In the embodiment shown in FIG. 7, the capacitive network 32 is charged using a fuel cell 35. One advantage of this embodiment is that the power to the system is not dependent on sunlight. One disadvantage, compared to using a solar panel, is that a fuel storage device will have to be periodically replenished by a user. In another embodiment, a system can use both solar panels and a fuel cell to provide power to the capacitive network 32. Other embodiments are also possible. For example, a wind generator or other power source described above could be used as a source of energy to charge the capacitive network.

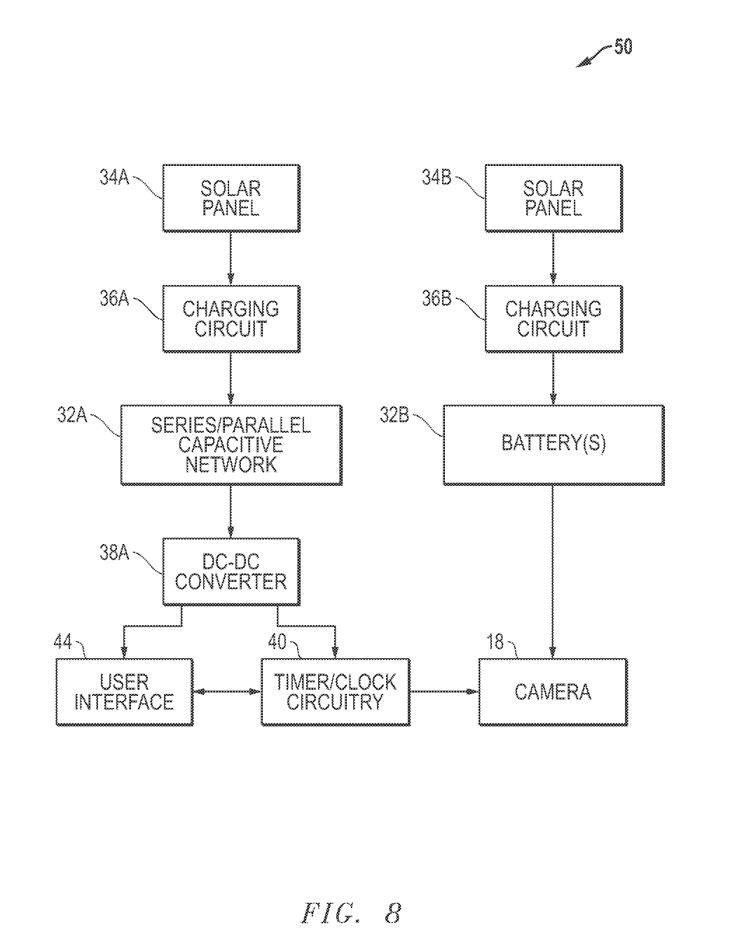

FIG. 8 is a block diagram showing another embodiment of a system with a camera or other load. FIG. 8 shows a block diagram of a system 50 that is similar to the systems described above, with a capacitive network for the DC-DC converter, user interface, and timer/clock circuitry. A second solar panel and charging circuit supplies power to battery 32B, which provide power to the camera or other load 18.

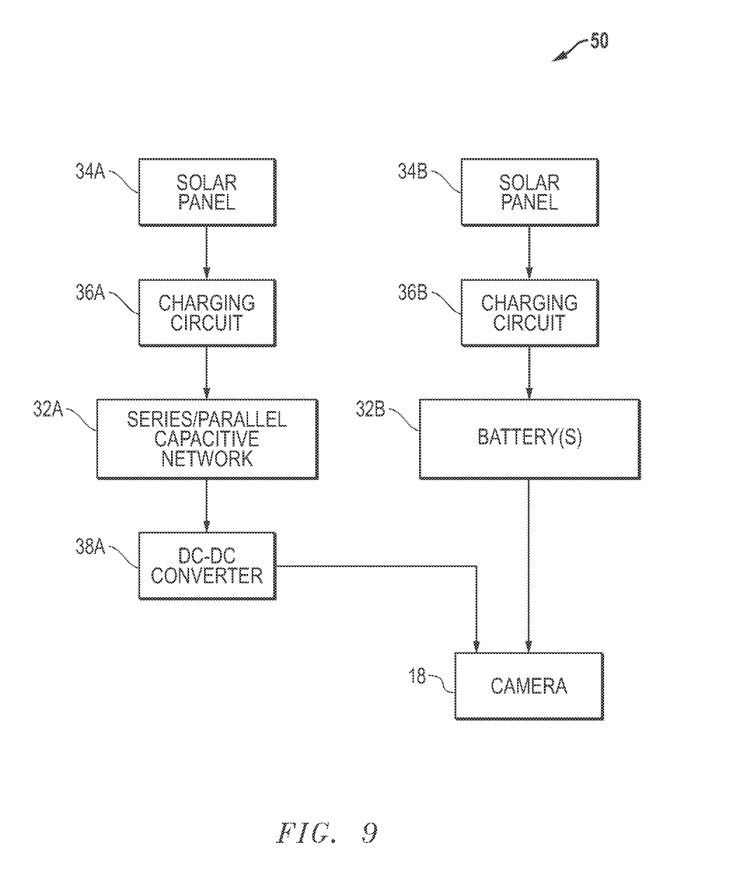

FIG. 9 shows a block diagram of a system 50 where a camera or other load 18 is powered by both a capacitive network 32A and batteries 32B. In this example, the camera or other load can rely on battery power when no power is available from the capacitive network, which will increase the life of the batteries.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible security systems available, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

We claim:

1. A method of operating a security camera comprising:
providing one or more solar panels;
storing energy from the one or more solar panels in one or more capacitors;
providing control circuitry operatively coupled to the security camera and to the one or more capacitors;
using the energy stored in the one or more capacitors to provide power to the security camera; and
configuring the control circuitry to prevent the security camera from depleting energy stored in the one or more capacitors below a critical level so that the control circuitry will have enough energy available to sustain full circuit operation, including critical logic operation and timekeeping operation, during time periods when the energy stored in the one or more capacitors is insufficient to maintain operation of both the control circuitry and the security camera during a period of time in which there may be limited amounts of solar energy for charging the capacitors back to a fully operational level.

2. The method of claim 1, wherein the charging of the one or more capacitors is at least partially disabled when the voltage of the one or more capacitors reaches a threshold voltage.

3. The method of claim 1, wherein the security camera is powered without using power from a non-photovoltaic power source such as a chemical battery.

4. The method of claim 1, further comprising using a DC-DC converter to step the capacitor voltage up or down to provide a desired steady voltage level to the security camera, even as the capacitor voltages fall.

5. The method of claim 1, wherein the control circuitry is programmable by a user to activate the security camera at predetermined intervals and durations.

6. The method of claim 1, wherein the one or more capacitors comprises first and second separate capacitive networks, wherein the first capacitive network provides power to the control circuitry, and the second capacitive network provides power to the security camera.

7.
